(19) United States
(12) Patent Application Publication
(10) Pub. No.: US 2024/0105918 A1
(43) Pub. Date: Mar. 28, 2024

(54) POSITIVE ELECTRODE MATERIAL FOR LITHIUM SECONDARY BATTERY AND MANUFACTURING METHOD THEREFOR

(71) Applicants: Hyundai Motor Company, Seoul (KR); Kia Corporation, Seoul (KR); Incheon National University Research & Business Foundation, Incheon (KR)

(72) Inventors: Seung Min Oh, Incheon (KR); Sung Ho Ban, Hwaseong-Si (KR); Sang Hun Lee, Paju-Si (KR); Chang Hoon Song, Seoul (KR); Yoon Sung Lee, Suwon-Si (KR); Ko Eun Kim, Cheongju-Si (KR); Van Chuong Ho, Incheon (KR); Jun Young Mun, Seoul (KR)

(21) Appl. No.: 18/217,862

(22) Filed: Jul. 3, 2023

(30) Foreign Application Priority Data
Sep. 26, 2022 (KR) 10-2022-0121626

(51) Int. Cl. H01M 4/36; C01G 53/00; H01M 4/131; H01M 4/133; H01M 4/505; H01M 4/525; H01M 4/587

(52) U.S. Cl. CPC H01M 4/366; C01G 53/50; H01M 4/131; H01M 4/133; H01M 4/505; H01M 4/525; H01M 4/587; H01M 2004/021

(57) ABSTRACT

A positive electrode material for a lithium secondary battery and a manufacturing method therefor are provided. The positive electrode material may have carbon nanotubes stably attached to a surface of an active material and may exhibit increased electron conductivity and improved surface stability. The positive electrode material for a lithium secondary battery may comprises: a positive electrode active material core comprising a Li—Ni—Co—Mn-M-O-based material, where M is a transition metal; and a carbon nanotube coating layer on a surface of the positive electrode active material core. Carbon nanotubes (CNT) may be in an amount of 1-5 wt %, based on 100 wt % of the positive electrode active material core.

### CROSS-REFERENCE TO RELATED APPLICATION(S)

This application is based on and claims priority under 35 U.S.C. 119 to Korean Patent Application No. 10-2022-0121626, filed on Sep. 26, 2022, in the Korean Intellectual Property Office, the disclosure of which is herein incorporated by reference in its entirety.

### BACKGROUND

### 1. Field

The present disclosure relates to a positive electrode material for a lithium secondary battery and a method for manufacturing same.

### 2. Discussion of the Background

Secondary batteries may be used as bulk power storage batteries for electric cars, battery energy storage systems, etc., and as compact, high-performance energy sources for portable electric devices, such as cellular phones, camcorders, laptop computers, and so on. With the aim of miniaturization and continuous operation of portable electronic devices for a long period of time, there is a demand for secondary batteries capable of realizing small size and high capacity, along with weight reduction of parts and low power consumption.

Particularly, a lithium ion battery representative of secondary batteries are higher in energy density, larger in capacitance per area, lower in self-discharge rate, and longer in lifespan than nickel manganese batteries or nickel cadmium batteries. A lithium ion battery has no memory effects, thus enjoying the characteristics of convenience of use and long life span.

A lithium secondary battery may include a positive electrode and a negative electrode, each composed of an active material capable of intercalation and deintercalation, with an electrolyte filling therebetween, wherein electric energy is generated and stored as redox reactions occur with intercalation/deintercalation of lithium ions in the positive and the negative electrode.

Such a lithium secondary battery may be composed of a positive electrode material, an electrolyte, a separator, and a negative electrode material, and maintenance of a stable interfacial reaction between the components may be very important to ensure long life and reliability in the battery.

In order to improve the performance of the lithium secondary battery, research is continuously being conducted into improving positive electrode materials. Particularly, extensive research has been focused on the development of high-performance and high-stability lithium secondary batteries.

The foregoing is intended merely to aid in the understanding of the background of the present disclosure, but is not to be construed to mean that the present disclosure falls within the purview of the related art that is already known to those skilled in the art.

### SUMMARY

The following summary presents a simplified summary of certain features. The summary is not an extensive overview and is not intended to identify key or critical elements.

Ni-rich positive electrode active materials may be used as positive electrode materials.

However, Ni-rich positive electrode active materials are poor in electron conductivity and have relatively low ionic conductivity compared to other positive electrode active materials. This may be vulnerable to an increase in resistance during the charge/discharge cycles of the secondary battery, and acts as a barrier to high-speed charging and discharging performance.

Ni-rich positive electrode active materials may have unstable surfaces. The Ni³⁺ state may be chemically unstable condition and when exposed to an electrolyte, undergoes an accelerated electrochemical side reaction to increase the surface resistance, thereby deteriorating the life-span characteristic and causing a cell-swelling phenomenon in the secondary battery.

In recent years, studies have been conducted on technology for applying a carbon component in various ways to a surface of a positive electrode active material capable of realizing a high energy density in order to improve electron conductivity and surface safety.

A method of coating a positive electrode active material with carbon by using a carbon precursor and a method of depositing carbon on the surface of a positive electrode active material by sputtering may be considered.

In a carbon coating method using a carbon precursor, a carbon-containing organic material (sucrose, glycol, etc.) may be primarily applied to the surface of a positive electrode active material, followed by conducting a post-thermal carbonization process for high conductive carbonization. In this regard, a higher carbonization temperature forms carbon of higher crystallinity, with the consequent improvement of the electron conductivity. However, a temperature higher than 400° C. causes carbon thermal reduction in which carbon and oxygen are reacted to generate CO₂. Thus, if the carbonization process may be carried out at 400° C. or higher, it may be indispensable to control a non-active Ar atmosphere. However, oxide-based materials are vulnerable to high-temperature Ar heat treatment and thus are impossible to subject to an Ar carbonization process at a high temperature.

Hence, the application of carbon coating methods using carbon precursors may be very limited to polyanion-based negative electrode materials with excellent crystalline stability, such as LiFePO₄, etc., or oxide materials with high stability, such as Li₄T₁₅Oi₂, NaCrO₂, etc., and may not be allowed to Ni-rich materials that are of poor stability.

The method of depositing carbon on the surface of a positive electrode active material by sputtering may be advantageous in that it may be free of oxide carbonization thermal treatment processes, but exhibits only limited improvement in conductivity because of inability to coat carbon of high crystallinity. Also, the restriction of carbon sputtering process facility makes the mass production difficult.

A technique of simply mixing and using carbon nanotubes (CNT) as a conductive material for electrodes has been suggested to introduce highly conductive carbon materials.

However, if a positive electrode active material and carbon nanotubes (CNT) are simply mixed, the uniform dispersion of carbon nanotubes (CNT) on the surface of the positive electrode active material may be limited and a great amount of carbon nanotubes (CNT) may be required for securing desired conductivity.

The present disclosure provides a positive electrode material and a manufacturing method therefor, wherein the positive electrode material has carbon nanotubes stably attached onto the surface of a Ni-rich positive electrode active material thereof and thus exhibits increased electron conductivity and improved surface stability while retaining the crystalline structure of the Ni-rich positive electrode active material that can realize a high energy density. A positive electrode material may be for a lithium secondary battery. The positive electrode material may comprise carbon nanotubes stably attached onto the surface of the active material and may exhibit increased electron conductivity and improved surface stability.

The technical subjects pursued in the present disclosure may not be limited to the above mentioned technical subjects, and other technical subjects which are not mentioned may be clearly understood, through the following descriptions, by those skilled in the art to which the present disclosure pertains.

An electrode material may comprise: an electrode active material core comprising a Li—Ni—Co—Mn-M-O-based material, where M is a transition metal; and a carbon nanotube coating layer on a surface of the electrode active material core, wherein the carbon nanotube coating layer comprises carbon nanotubes in an amount of about 1-5 wt %, based on 100 wt % of the electrode active material core.

The electrode active material core may comprise LiNiₓCo_{y}Mn_{z}M_{1-x-y-z}O₂, where 0.3<x<1, 0<y<0.4, and 0<z<0.7. The electrode active material core may comprise particles with a particle size of 5 Vim or greater. The carbon nanotube coating layer may have a thickness of 5-21 nm. The carbon nanotubes may have a length of 200 nm or longer. The electrode material may have a ratio, of D-band width to G-band width, corresponding to 0.49 or between 0.01 and 0.49.

A method of manufacturing a electrode material may comprise: preparing a electrode active material core comprising a Li—Ni—Co—Mn-M-O-based material, where M is a transition metal; and coating the electrode active material core with carbon nanotubes to form a carbon nanotube coating layer.

The electrode active material core may comprise LiNiₓCo_{y}Mn_{z}M_{1-x-y-z}O₂, where 0.3<x<1, 0<y<0.4, and 0<z<0.7. The coating the electrode active material core may comprise forming the carbon nanotube coating layer by attaching the carbon nanotubes to a surface of the electrode active material core.

The coating the electrode active material core may comprise: putting the electrode active material core and the carbon nanotubes into a milling machine, wherein the milling machine comprises a rotor; and rotating the cylindrical rotor without blades around a central axis of the milling machine at 2000˜4000 rpm for 10-20 minutes to attach the carbon nanotubes to the surface of the electrode active material core.

The carbon nanotubes attached to the surface of the electrode active material core may have an amount of about 1-5 wt %, based on 100 wt % of the electrode active material core. The electrode active material core may have a particle size of 5 μm or greater, and wherein the carbon nanotubes attached to the surface of the electrode active material core has a length of 200 nm or longer. The carbon nanotube coating layer that is formed on the surface of the electrode active material core may have a thickness of 5-21 nm. The coating the electrode active material core may be carried out in a dry manner.

A lithium secondary battery may comprise: a positive electrode comprising a positive electrode material, wherein the positive electrode material comprises: a positive electrode active material core comprising a Li—Ni—Co—Mn-M-O-based material, where M is a transition metal; and a carbon nanotube coating layer on a surface of the positive electrode active material core, wherein the carbon nanotube coating layer comprises carbon nanotubes in an amount of about 1-5 wt %, based on 100 wt % of the positive electrode active material core; a negative electrode comprising a negative electrode material; and an electrolyte.

The positive electrode active material core may comprise LiNiₓCo_{y}Mn_{z}M_{1-x-y-z}O₂, where 0.3<x<1, 0<y<0.4, and 0<z<0.7. The positive electrode active material core may comprise particles with a particle size of 5 μm or greater. The carbon nanotube coating layer may have a thickness of 5-21 nm. The positive electrode material has a ratio, of D-band width to G-band width, corresponding to 0.49 or between 0.01 and 0.49.

The positive electrode material may have carbon nanotubes stably attached onto the surface of a positive electrode active material core and thus can maintain a high energy density and exhibit increased electron conductivity and improved surface stability while retaining the crystalline structure of the Ni-rich positive electrode active material core.

Particularly, carbon nanotubes (CNT) are stably attached to the surface of the positive electrode active material core by physical milling without affecting the positive electrode active material core, whereby the positive electrode material may be possible to produce at a mass scale with no adverse effect of the coating on the matrix.

Accordingly, the present disclosure can make a contribution to the establishment of pure electric vehicle models, and it may be expected to reduce the manufacturing cost of pure electric vehicles, which are battery-centered, compared to hybrid or derivative electric vehicles, which are manufactured in such a manner as to combine a driving device with an existing designed vehicle structure.

These and other features and advantages are described in greater detail below.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a schematic view of a positive electrode containing a positive electrode material for a lithium secondary battery;

FIG. 2 is a schematic view illustrating a mode of coating a positive electrode active material core with carbon nanotubes during the manufacture of a positive electrode material for a lithium secondary battery;

FIG. 3a shows SEM images of a positive electrode active material core in a bare state;

FIG. 3b shows SEM images of the positive electrode material according to Example 1.

FIG. 4 shows SEM images of carbon nanotubes before coating (pristine CNT) and nanotubes of Examples 1 to 3, with the comparison of length thereamong;

FIG. 5 shows SEM images of the positive electrode material according to Comparative Example 1.

FIG. 6 is a plot showing lifespan characteristics of coin cells according to Examples 1 and 2, Comparative Example 1, and Control 1;

FIG. 7 shows Raman spectra of MWCNT of Examples 1 and 3 and Comparative Example 2 and MWCNT before coating (pristine MWCNT);

FIG. 8 is a plot showing lifespan characteristics of coin cells according to Examples 1, 3, and 4, and Comparative Examples 2, 3, and 4;

FIG. 9 shows TEM images of the positive electrode materials according to Examples 1 and 5 to 7;

FIG. 10 shows SEM images of the positive electrode materials according to the particle diameters of the positive electrode active material core; and

FIG. 11 is a plot showing lifespan characteristics of coin cells according to Example 1 and Controls 1 and 2.

### DETAILED DESCRIPTION

The present disclosure may be variously modified and include various examples in which specific features will be described in detail hereinbelow. However, it shall be understood that the specific features are not intended to limit the present disclosure thereto and cover all the modifications, equivalents and substitutions which belong to the idea and technical scope of the present disclosure.

Hereinafter, examples disclosed in the present specification will be described in detail with reference to the accompanying drawings, and the same or similar elements are given the same and similar reference numerals, so duplicate descriptions thereof will be omitted.

The terms “module” and “unit” used for the elements in the following description are given or interchangeably used in consideration of only the ease of writing the specification, and do not have distinct meanings or roles by themselves.

In describing the various examples disclosed in the present specification, when the detailed description of the relevant known technology is determined to unnecessarily obscure the gist of the present disclosure, the detailed description may be omitted. Further, the accompanying drawings are provided only for easy understanding of the examples disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

A singular expression may include a plural expression unless they are definitely different in the context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

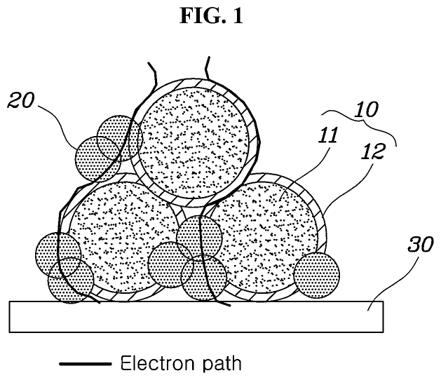

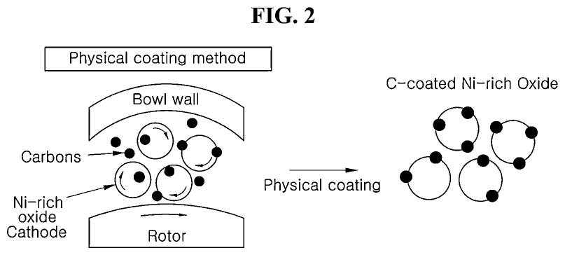

FIG. 1 is a schematic view of a positive electrode containing a positive electrode material for a lithium secondary battery, and FIG. 2 is a schematic view illustrating a mode of coating a positive electrode active material core with carbon nanotubes during the manufacture of a positive electrode material for a lithium secondary battery.

As shown in FIG. 1, a positive electrode material 10 for a lithium secondary battery may be a material forming a positive electrode applicable to a lithium secondary battery and includes a positive electrode active material core 11 and a carbon nanotube coating layer 12 formed on the surface of the positive electrode core 11. The lithium secondary battery includes: a positive electrode containing the positive electrode material 10; a negative electrode containing a negative electrode active material and an electrolyte. In FIG. 1, reference numerals 20 and 30 represent a conductive material and an electrode base for the positive electrode, respectively.

The positive electrode active material core allows for reversible intercalation and deintercalation of lithium ions and may be composed of a Li—Ni—Co—Mn-M-O-based material which may be in a Ni-rich state. In this regard, M represents a transition metal.

The positive electrode active material core may include LiNiₓCo_{y}Mn_{z}M_{1-x-y-z}O₂ which meets the condition of 0.3<x<1, 0<y<0.4, and 0<z<0.7.

The positive electrode active material core has a particle diameter of 5 μm or larger.

If the particle diameter of the positive electrode active material core may be less than 5 μm, the surface area in each particle of the positive electrode active material core may be too small to effectively attach the carbon nanotubes (CNT) thereto.

The carbon nanotube coating layer may be formed as the carbon nanotubes (CNT) are physically attached to the surface of the positive electrode active material core. In this regard, the carbon nanotubes (CNT) are a material to be physically attached to the surface of the positive electrode active material core in order to enhance the electron conductivity of the positive electrode material.

The carbon nanotubes attached to the surface of the positive electrode active material core may be 200 nm or longer in length so that the carbon nanotube coating layer can be formed at a uniform thickness across the surface of the positive electrode active material core. The carbon nanotubes account for the carbon nanotube coating layer may retain a length of 300 nm or longer.

Hence, the positive electrode material may have a D/G ratio, which is a ratio of D-band width to G-band width, of 0.49 (e.g., as analyzed by Raman spectroscopy).

The carbon nanotube coating layer ranges in thickness from 5 to 21 nm.

In this context, the carbon nanotubes (CNT) accounting for the carbon nanotube coating layer may be used in an amount of 1-5 wt %, based on 100 wt % of the positive electrode active material core.

Below, a manufacturing method for the positive electrode material formed as described above will be explained.

A method for manufacturing a positive electrode material for a lithium secondary battery may be largely divided into: a preparation step of preparing a positive electrode active material core; and a coating step of coating the positive electrode active material core with carbon nanotubes (CNT) to form a carbon nanotube coating layer.

The preparation step is to prepare a positive electrode active material core. A positive electrode active material core may be prepared using a Li—Ni—Co—Mn-M-O-based material (M=transition metal) which may be in a Ni-rich state.

In detail, the positive electrode active material core may be LiNiₓCo_{y}Mn_{z}M_{1-x-y-z}O₂ which meets the condition of 0.3<x<1, 0<y<0.4, 0<z<0.7.

As shown in FIG. 2, the coating step may be carried out by attaching carbon nanotubes (CNT) to the surface of the prepared surface positive electrode active material core in a physical coating manner, which may be a type of dry coating modes, to form a carbon nanotube coating layer on the positive electrode active material core.

For instance, a milling machine in which a cylindrical rotor rotates around the center thereof, with no blades equipped may be prepared, and the positive electrode active material core and the carbon nanotubes are introduced into the milling machine and the rotor may be rotated at 2000-4000 rpm for 10-20 minutes to attach the carbon nanotubes to the surface of the positive electrode active material core.

The carbon nanotube coating layer thus formed on the surface of the positive electrode active material core may be maintained at a thickness of 5-21 nm.

If the rotating speed of the milling machine may be less than 2000 rpm, the carbon nanotubes are not sufficiently attached to the surface of the positive electrode active material core. At a rotating speed exceeding 4000 rpm, the carbon nanotubes are cut and thus attached nonuniformly to the surface of the positive electrode active material core, resulting in a decrease in electron conductivity.

A coating time less than 10 minutes in the milling machine does not ensure the sufficient attachment of the carbon nanotubes to the surface of the positive electrode active material core. If the coating time is longer than 20 minutes, the carbon nanotubes are cut into short lengths.

The physical coating may be conducted to the extent that the length of the carbon nanotubes at the time of completing the coating is 30-70% of that of the carbon nanotubes initially introduced into the milling machine.

In the coating step, the amount of the carbon nanotubes (CNT) attached to the surface of the positive electrode active material core may be 1-5 wt %, based on 100 wt % of the positive electrode active material core.

Therefore, the positive electrode active material core has a particle diameter of 5 n or greater so that the carbon nanotubes are uniformly attached at a desired thickness to the positive electrode active material core. The carbon nanotubes forming the carbon nanotube coating layer on the surface of the positive electrode active material core retain a length of 200 nm or longer at the time of coating completion in the milling machine.

Various aspects of the present disclosure will be better understood through the following Examples and Comparative Examples.

First, positive electrode materials and lithium secondary batteries manufactured according to the Examples of the present disclosure were examined for conditions and performances, in comparison with Comparative Examples and controls.

### Example 1

LiNi_{0.89}Co_{0.04}Mn_{0.07}O₂ was prepared as a positive electrode active material core while multi-wall carbon nanotubes (MWCNT) were employed.

MWCNT was introduced in an amount of 2 wt %, based on 100 wt % of the positive electrode active material core, into a milling machine in which coating was then conducted at a rotation speed of 3000 rpm for 10 minutes. The resulting positive electrode material, a conductive material, and a binder were mixed at a ratio of 95:2:3 in an NMP solvent to prepare a slurry. This slurry was applied to an aluminum substrate, dried, rolled, and again dried in a vacuum oven before fabrication into R2032-type coil cell.

### Example 2

The coating was carried out in the same manner as in Example 1, except that the milling machine was rotated at a speed of 4000 rpm.

### Comparative Example 1

The coating was carried out in the same manner as in Example 1, except that the milling machine was rotated at a speed of 4000 rpm.

### Comparative Example 2

The coating was carried out in the same manner as in Example 1, except that the milling machine was rotated for 5 minutes.

### Example 3

The coating was carried out in the same manner as in Example 1, except that the milling machine was rotated for 10 minutes.

### Example 4

The coating was carried out in the same manner as in Example 1, except that the milling machine was rotated for 15 minutes.

### Comparative Example 3

The coating was carried out in the same manner as in Example 1, except that the milling machine was rotated for 25 minutes.

### Comparative Example 4

The coating was carried out in the same manner as in Example 1, except that the milling machine was rotated for 30 minutes.

### Example 5

The coating was carried out in the same manner as in Example 1, except that the carbon nanotubes were used in an amount of 1 wt %.

### Example 6

The coating was carried out in the same manner as in Example 1, except that the carbon nanotubes were used in an amount of 3 wt %.

### Example 7

The coating was carried out in the same manner as in Example 1, except that the carbon nanotubes were used in an amount of 5 wt %.

<Control 1; Bare>

The same positive electrode active material core, conductive material, and binder as in Example 1 were mixed at a ratio of 95:2:3 in an NMP solvent to prepare a slurry. This slurry was applied to an aluminum substrate, dried, rolled, and again dried in a vacuum oven before fabrication into R2032-type coil cell.

<Control 2; Simple Mixing of CNT>

A positive electrode active material core, MWCNT, a conductive material, and a binder were simply mixed in the same respective amounts as in Example 1 to prepare a slurry. This slurry was applied to an aluminum substrate, dried, rolled, and again dried in a vacuum oven before fabrication into R2032-type coil cell.

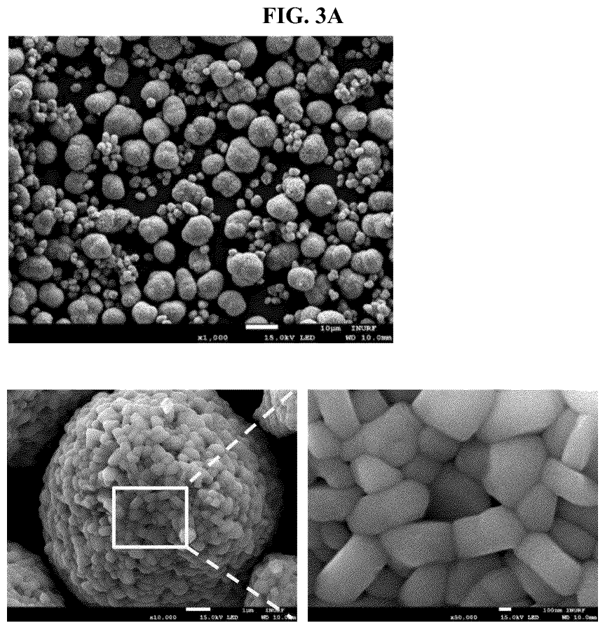

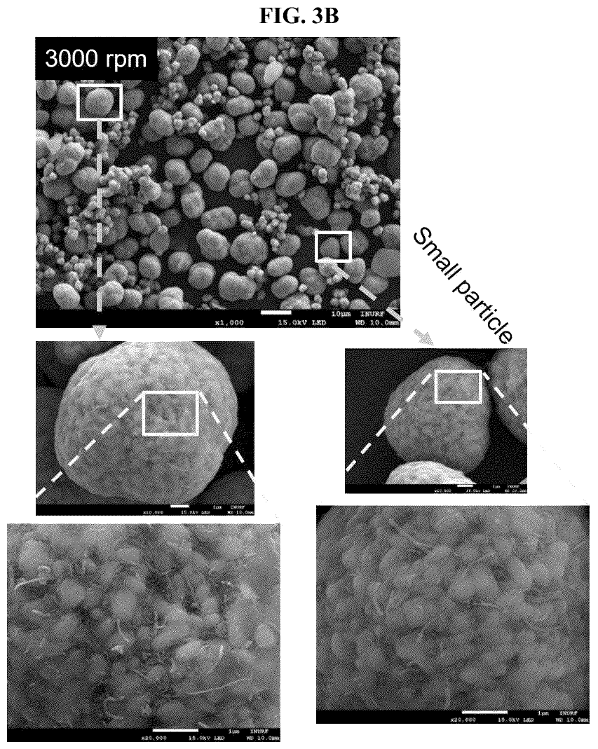

To examine structural characteristics of the positive electrode materials according to the rotation speed of the milling machine in the coating step, the positive electrode materials according to Examples 1 and 2 and Comparative Example 1, the positive electrode active material core before coating, and carbon nanotubes were observed under a scanning electron microscope and the results are given in FIGS. 3a, 3b, 4, and 5.

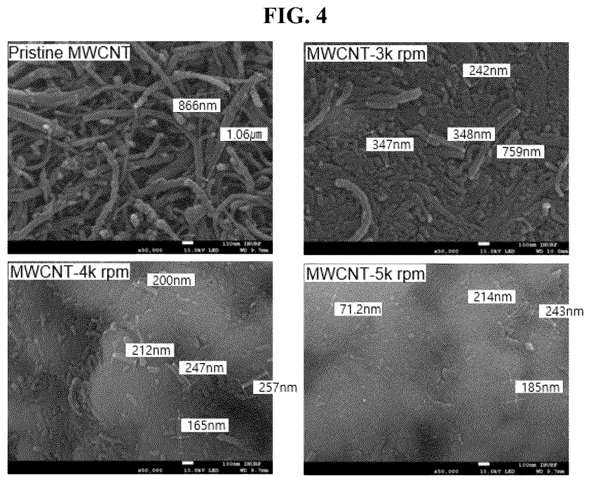

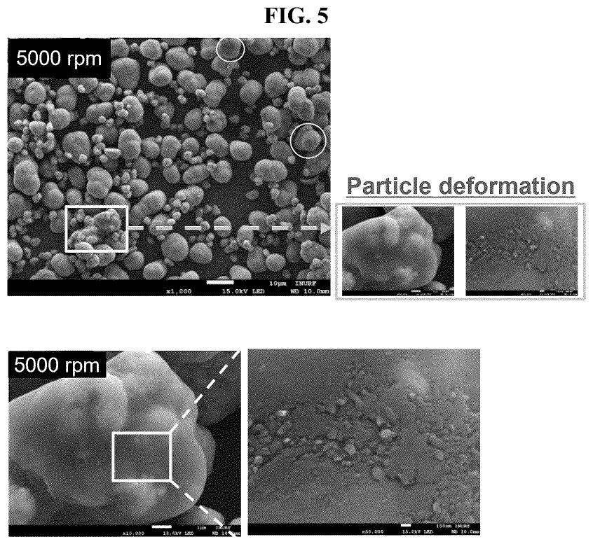

FIG. 3a shows SEM images of a positive electrode active material core in a bare state and FIG. 3b shows SEM images of the positive electrode material according to Example 1. FIG. 4 shows SEM images of carbon nanotubes before coating (pristine CNT) and nanotubes of Examples 1 to 3, with the comparison of length thereamong. FIG. 5 shows SEM images of the positive electrode material according to Comparative Example 1.

Comparing FIGS. 3a and 3b, it was observed that the carbon nanotubes were uniformly attached to the surface of the positive electrode active material core to form a carbon nanotube coating layer if the positive electrode material was manufactured according to the present disclosure. Thus, a carbon nanotube coating layer can be formed as carbon nanotubes (CNT) are attached to the surface of the positive electrode active material core by physical coating, which may be a dry manner, with the aid of a milling machine.

As shown in FIG. 4, it was also found that if the rotation speed of the milling machine is higher, the carbon nanotubes accounting for the carbon nanotube coating layer are shorter.

Particularly, as can be understood from the images of FIG. 5, positive electrode active material core was cracked or broken, along with the shortening of the carbon nanotubes, in Comparative Example 1 in which the rotation speed was too high.

Therefore, the rotation speed of the milling machine may be maintained at 2000 to 4000 rpm.

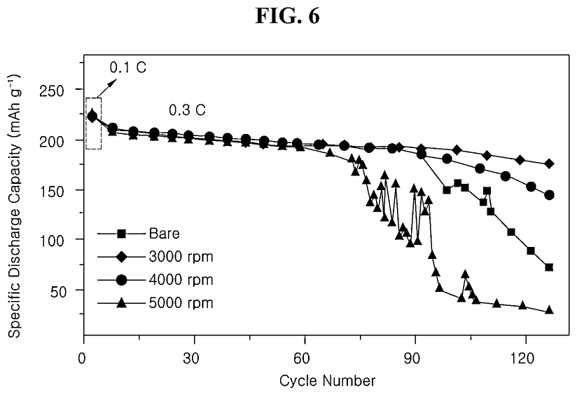

Examination was made of lifespan characteristics of the coin cells according to the rotation speed of the milling machine in the coating step. In this regard, the coin cells of Examples 1 and 2, Comparative Example 1, and Control 1 were measured for lifespan and the results are depicted in FIG. 6.

As shown in FIG. 6, Examples 1 and 2 were observed to have improved lifespan characteristics, compared to Control 1 whereas Comparative Example 1 exhibited poor lifespan characteristics, compared to Control 1, due to its too high rotation speed.

Therefore, the data indicates that the milling machine may be operated at a rotation speed of 2000 to 4000 rpm.

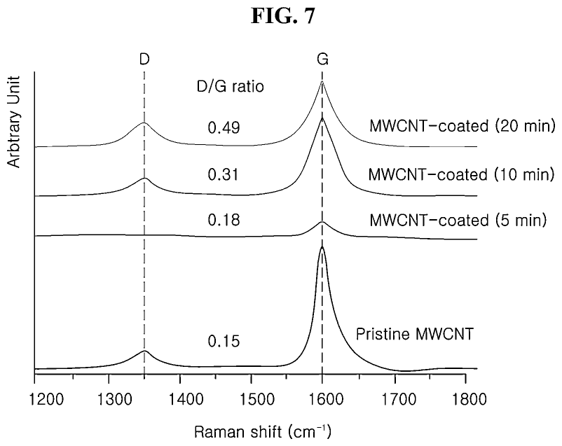

Structural characteristics of the positive electrode materials were examined according to the coating time of the milling machine in the coating step. In this regard, MWCNT of Examples 1 and 3 and Comparative Example 2 and MWCNT before coating (pristine MWCNT) were analyzed by Raman spectroscopy, and the results are depicted in FIG. 7.

As can be seen in FIG. 7, the positive electrode materials according to Examples 1 and 3 had a D/G ratio (ratio of D-band width to G-band width) of 0.49 or less (e.g., as analyzed by Raman spectroscopy).

Also, the longer was the coating time, the more the carbon nanotubes were disconnected.

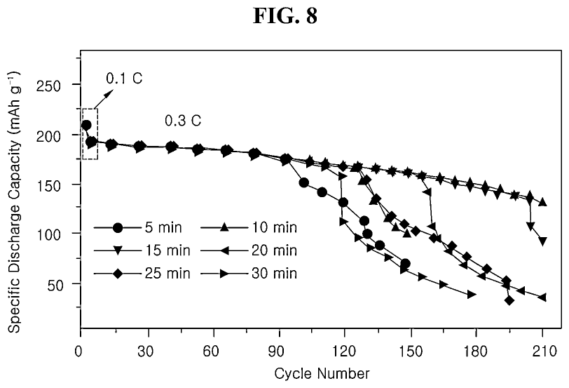

The coin cells were examined for lifespan characteristics according to the coating time of the milling machine in the coating step. To this end, lifespans of the coin cells of Examples 1, 3, and 4 and Comparative Examples 2, 3, and 4 were measured and are depicted in FIG. 8.

As shown in FIG. 8, Examples 1, 3, and 4 which met the suggested coating time of 10-20 minutes in the milling machine exhibited relatively longer lifespan characteristics, compared to the Comparative Examples.

Comparative Example 2 in which the coating time of the milling machine was shorter than the suggested time was lower in lifespan than the Examples. Also, poor lifespan characteristics were detected in Comparative Examples 3 and 4 in which the coating time of the milling machine was longer than the suggested time, compared to the Examples.

Hence, the coating time of the milling machine may be maintained for 10 to 20 minutes.

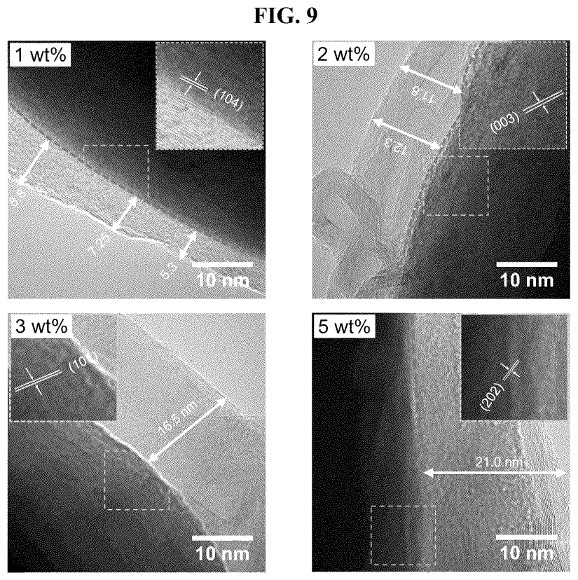

Then, examination was made of the thickness of the carbon nanotube coating layer according to the coating amount of the carbon nanotubes. For this, the carbon nanotube coating layers of Examples 1 and 5 to 7 were subjected to transmission electron microscopy and the TEM images thus obtained are given in FIG. 9.

As shown in FIG. 9, it was observed that the more the content of carbon nanotubes, the thicker the carbon nanotube coating layer. Among others, if the content of carbon nanotubes was 1-5 wt % as suggested in the present disclosure, the carbon nanotube coating layer was maintained at the thickness of 5-21 nm.

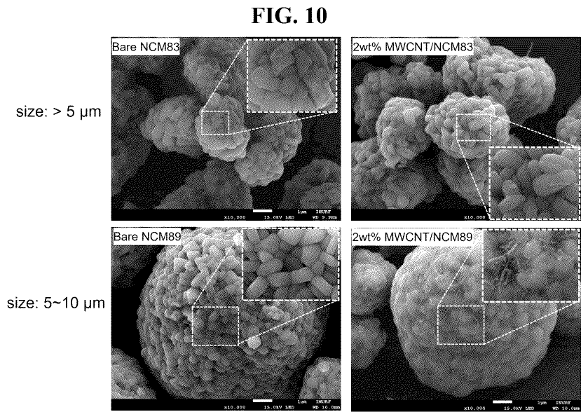

Structural characteristics of the positive electrode materials according to particle diameters of the positive electrode active material cores were examined. To this end, positive electrode materials were prepared as in Example 1. In this regard, positive electrode materials were prepared using positive electrode active material cores having particle diameters of less than 5 μm and 5-10 μm, and analyzed by scanning electron microscopy. The resulting SEM images are depicted in FIG. 10.

As shown in FIG. 10, if the size of the positive electrode active material core was below the lower limit of the suggested range, the surface area of the positive electrode active material core was too small to allow for effective attachment of the carbon nanotubes (CNT) to the surface of the positive electrode active material core.

If the size of the positive electrode active material core was within the suggested range, carbon nanotubes (CNT) were attached at a desired level to the surface of the positive electrode active material core.

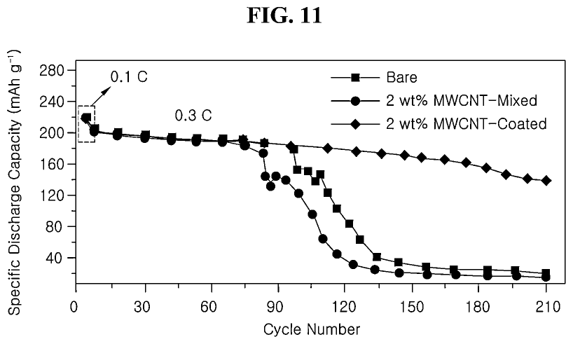

Examination was made of the lifespan characteristics of the coil cells according to the presence or absence of the carbon nanotube coating. For this, the coil cells of Example 1 and Controls 1 and 2 were measured for lifespans and the results are depicted in FIG. 11.

As can be understood from data of FIG. 11, the coin cell of Example 1 in which carbon nanotubes were physically attached to the surface of the positive electrode active material core exhibited improved lifespan characteristics, compared to Control 1 in which no carbon nanotubes were used and Control 2 in which carbon nanotubes were simply mixed with the core.

Therefore, the lifespan of the lithium secondary battery can be prolonged by the carbon nanotube coating layer which may be formed by physically attaching carbon nanotubes to the positive electrode active material core.

A positive electrode material for a lithium secondary battery according to the present disclosure includes a positive electrode active material core composed of a Li—Ni—Co—Mn-M-O-based material (M=transition metal); and a carbon nanotube coating layer on the surface of the positive electrode active material core, wherein the carbon nanotubes (CNT) are used in an amount of 1-5 wt %, based on 100 wt % of the positive electrode active material core.

The positive electrode active material core includes LiNiₓCo_{y}Mn_{z}M_{1-x-y-z}O₂, which meets the condition of 0.3<x<1, 0<y<0.4, and 0<z<0.7.

The positive electrode active material core includes particles with a particle size of 5 μm or greater.

The carbon nanotube coating layer has a thickness of 5-21 nm.

The carbon nanotubes accounting for the carbon nanotube coating layer have a length of 200 nm or longer.

The positive electrode material has a ratio of D-band width to G-band width (D/G ratio) of 0.49 or less as analyzed by Raman spectroscopy.

A method for manufacturing a positive electrode material for a lithium secondary battery may include: a preparation step of preparing a positive electrode active material core composed of a Li—Ni—Co—Mn-M-O-based material (M=transition metal); and a coating step of coating the positive electrode active material core with carbon nanotubes (CNT) to form a carbon nanotube coating layer.

The positive electrode active material core prepared in the preparation step includes LiNiₓCo_{y}Mn_{z}M_{1-x-y-z}O₂ which meets the condition of 0.3<x<1, 0<y<0.4, and 0<z<0.7.

The coating step may be adapted to form a carbon nanotube coating layer by attaching the carbon nanotubes (CNT) to the surface of the positive electrode active material core in a physical coating manner.

In the coating step, the positive electrode active material core and the carbon nanotubes are introduced into a milling machine which has a rotor rotating around the central axis thereof and no blades, and the carbon nanotubes are attached to the surface of the positive electrode active material by rotating the rotor at 2000˜4000 rpm for 10-20 minutes.

In the coating step, the carbon nanotubes (CNT) attached to the surface of the positive electrode active material have an amount of 1-5 wt %, based on 100 wt % of the positive electrode active material core.

In the coating step, the positive electrode active material core has a particle size of 5 μm or greater and the carbon nanotubes attached to the surface of the positive electrode active material core have a length of 200 nm or longer.

In the coating step, the carbon nanotube coating layer formed on the surface of the positive electrode active material core has a thickness of 5-21 nm.

The coating step may be carried out in a dry manner.

A lithium secondary battery may include a positive electrode containing a positive electrode material; a negative electrode containing a negative electrode material; and an electrolyte, wherein the positive electrode material includes a positive electrode active material core composed of a Li—Ni—Co—Mn-M-O-based material (M=transition metal); and a carbon nanotube coating layer on the surface of the positive electrode active material core, wherein the carbon nanotubes (CNT) are used in an amount of 1-5 wt %, based on 100 wt % of the positive electrode active material core.

Although the present disclosure has been described with reference to the accompanying drawings and the above examples thereof, the present disclosure is not limited thereto but defined by the appended claims. Therefore, those skilled in the art may make various modifications and changes to the present disclosure without departing from the technical idea of the present disclosure defined by the appended claims.

What is claimed is:

1. An electrode material comprising:
an electrode active material core comprising a Li—Ni—Co—Mn-M-O-based material, where M is a transition metal; and
a carbon nanotube coating layer on a surface of the electrode active material core,
wherein the carbon nanotube coating layer comprises carbon nanotubes in an amount of about 1-5 wt %, based on 100 wt % of the electrode active material core.

2. The electrode material of claim 1, wherein the electrode active material core comprises LiNiₓCo_{y}Mn_{z}M_{1-x-y-z}O₂, where 0.3<x<1, 0<y<0.4, and 0<z<0.7.

3. The electrode material of claim 1, wherein the electrode active material core comprises particles with a particle size of 5 μm or greater.

4. The electrode material of claim 1, wherein the carbon nanotube coating layer has a thickness of 5-21 nm.

5. The electrode material of claim 4, wherein each of the carbon nanotubes has a length of 200 nm or longer.

6. The electrode material of claim 1, wherein the electrode material has a ratio, of D-band width to G-band width, corresponding to 0.49 or less.

7. A method of manufacturing an electrode material, the method comprising:
preparing an electrode active material core comprising a Li—Ni—Co—Mn-M-O-based material, where M is a transition metal; and
coating the electrode active material core with carbon nanotubes to form a carbon nanotube coating layer.

8. The method of claim 7, wherein the electrode active material core comprises LiNiₓCo_{y}Mn_{z}M_{1-x-y-z}O₂, where 0.3<x<1, 0<y<0.4, and 0<z<0.7.

9. The method of claim 7, wherein the coating the electrode active material core comprises forming the carbon nanotube coating layer by attaching the carbon nanotubes to a surface of the electrode active material core.

10. The method of claim 9, wherein the coating the electrode active material core comprises:
putting the electrode active material core and the carbon nanotubes into a milling machine, wherein the milling machine comprises a rotor, and wherein the cylindrical rotor has no blades; and
rotating the cylindrical rotor around a central axis of the milling machine at 2000˜4000 rpm for 10-20 minutes to attach the carbon nanotubes to the surface of the electrode active material core.

11. The method of claim 10, wherein the carbon nanotubes attached to the surface of the electrode active material core has an amount of about 1-5 wt %, based on 100 wt % of the electrode active material core.

12. The method of claim 10, wherein the electrode active material core has a particle size of 5 μm or greater, and
wherein the carbon nanotubes attached to the surface of the electrode active material core has a length of 200 nm or longer.

13. The method of claim 10, wherein the carbon nanotube coating layer that is formed on the surface of the electrode active material core has a thickness of 5-21 nm.

14. The method of claim 10, wherein the coating the electrode active material core is carried out in a dry manner.

15. A lithium secondary battery comprising:
a positive electrode comprising a positive electrode material, wherein the positive electrode material comprises:
a positive electrode active material core comprising a Li—Ni—Co—Mn-M-O-based material, where M is a transition metal; and
a carbon nanotube coating layer on a surface of the positive electrode active material core, wherein the carbon nanotube coating layer comprises carbon nanotubes in an amount of about 1-5 wt %, based on 100 wt % of the positive electrode active material core;
a negative electrode comprising a negative electrode material; and
an electrolyte.

16. The lithium secondary battery of claim 15, wherein the positive electrode active material core comprises LiNiₓCo_{y}Mn_{z}M_{1-x-y-z}O₂, where 0.3<x<1, 0<y<0.4, and 0<z<0.7.

17. The lithium secondary battery of claim 15, wherein the positive electrode active material core comprises particles with a particle size of 5 μm or greater.

18. The lithium secondary battery of claim 15, wherein the carbon nanotube coating layer has a thickness of 5-21 nm.

19. The lithium secondary battery of claim 18, wherein the positive electrode material has a ratio, of D-band width to G-band width, corresponding to 0.49 or less.
